(19) United States
(12) Patent Application Publication
(10) Pub. No.: US 2006/0043635 A1
(43) Pub. Date: Mar. 2, 2006

(54) Singular and co-molded pre-forms

(76) Inventor: Lauren A. Groth, Cypress, TX (US)

Correspondence Address: BUTZEL LONG, 350 SOUTH MAIN STREET, SUITE 300, ANN ARBOR, MI, 48104, US

(21) Appl. No.: 11/230,441

(22) Filed: Sep. 20, 2005

Related U.S. Application Data
(63) Continuation-in-part of application No. 10/699,130, filed on Oct. 31, 2003.

(51) Int. Cl. B29C 33/40

(52) U.S. Cl. 264/219; 29/858; 264/272.11

(57) ABSTRACT

Molded pre-forms that are used to protect electronic components and assemblies from damage due to vibration, shock and/or thermal exposure. The pre-forms can be singularly molded or co-molded. Co-molded pre-forms can include hard surface layers over softer molded compositions. The pre-forms are molded in molds that are formed using modified images obtained from printed circuit boards having the electronic components thereon. Images of the printed circuit boards are obtained and modified to improve vibrational dampening and/or heat transfer. The molded pre-forms allow for access to the printed circuit boards for purposes of replacing or repairing the printed circuit boards.

### RELATED APPLICATIONS

The present application is a Continuation-In-Part of U.S. patent application Ser. No. 10/699,130, filed Oct. 31, 2003, to which priority if being claims under 35 U.S.C. § 120 and of which the complete disclosure is hereby expressly incorporated herein by reference.

### TECHNICAL FIELD

The present invention relates to protecting electronic components and assemblies from damage due to vibration, shock and/or thermal exposure. More particularly, the present invention is directed to the production and use of molded pre-forms and their use to protect electronic components and assemblies from damage due to vibration, shock and/or thermal exposure.

### BACKGROUND ART

Electronic component assemblies that are used in “down hole” applications in oil and gas well drilling logging and measurement activities are an extreme example of electronic component assemblies that are subject to significant vibration and shock which are present in the drill string axial direction, along both transverse axes, and rotational acceleration about the axis and high heat/thermal exposure. The electronic component assemblies survive long hours down hole only if: (1) the mounting support offers protection from acceleration induced forces that cause relative strain between components and (2) there is a sufficient heat conduit in place to transfer the heat generated by the printed circuit board (PCB) so that PCB damage does not occur. Failures result too often and have serious economic consequences since, unlike other applications of electronic component assemblies and applications thereof, electronic component assemblies in down hole applications can fail far down while drilling and have to be recovered for repair.

Known mounting methods for electronic components such as printed circuit boards involve the use of support structures called “Subs” and or chassis and suspending the assemblies supported thereon in confining, pressure proof, enclosures. The pressure proof enclosures are attached to drill strings to which drill bits are attached or wire line strings where there is no drill bit attached. During a drilling operation, the drill strings are the origin of the most serious shock and linear vibration. The acceleration forces generated during drilling are transmitted by way of the drill string to the enclosure and the attached “Sub” or chassis to the electronic assembly and components. Failure of the electronic component assemblies results when: (1) the acceleration forces cause relative motion between PCBs and their attached components and or (2) high heat/thermal exposure damages the PCB since there is no conduit in place to pull the heat from the PCB and transfer it out.

Two currently used mounting options include: (1) attachment of PCBs to strongbacks with screws with a sheet of elastomer captured between PCBs and strongbacks and; (2) positioning PCBs in openings, or cavities, in “Subs” and filling the remaining volume with elastomer that is cast and cured in place (a type of potting method). A method used more frequently involves placing a PCB in a mold (that accurately fits the geometry of the cavity in the “Sub”) and casting or encapsulating the PCB with an elastomer. After curing the encapsulated PCB is removed from the mold and inserted into the cavity in the “Sub” or directly into the confining structure such as a pressure barrel. In both cases, the chassis and or “Sub,” with the electronic assemblies in place, is inserted in the bore of a confining structure, such as a tubular pressure barrel. In many cases the electronic assembly (encapsulated PCB) is placed directly into a confining structure cavity, such as a pressure barrel.

The first mounting option causes stress concentrations at the screws where acceleration forces are transmitted from the chassis and/or “Sub” to the PCBs. In addition, temperature changes cause relative thermal expansion between PCBs and “Subs” or chassis and strains the screw attachment points.

The second mounting option provides cushioning for all components against acceleration forces delivered through the strongback. However, differential thermal expansion between the elastomer and “Sub” causes forced migration of elastomer in unpredictable amounts and directions. As a result, destructive strains force relative movement between PCB and attached components.

U.S. Pat. No. 4,891,734 to More et al. provides a mounting option that is based upon the premise that the ideal support for electronic components will cushion all components about equally, will allow inevitable elastomer migration, very localized, in known directions and in known amounts, and that small movements allowed by cushioning can be accommodated by free moving conductors sufficiently short and supported to prevent their becoming a vibrating independent mass.

U.S. Pat. No. 4,891,734 to More et al. discloses enclosing electronic assemblies in elastomeric bodies that are separately molded to fit the confining enclosures of strongbacks that are provided with cavities for the elastomeric bodies and configured to be received in tubular shrouds. The electronic assemblies are positioned in molds shaped to represent the cavities of the strongbacks and elastomeric material is cast around the assembly. Only a connector is exposed at the elastomer surface.

Potting or encapsulating electronic components to protect them from vibration, shock and/or thermal exposure has been used for individual components, component assemblies, PCBs, circuit boards, etc. in all types of applications. A major disadvantage associated with potting an encapsulation processes is that it is difficult to access and repair electronic components that are potted or encapsulated. While it is possible remove electronic components from potting and encapsulating materials, such processes are prohibitly tedious. The general practice is to merely replace rather than repair potted or encapsulated electronic components. Accordingly, it is not practical to pot or encapsulate components that are desired to be repaired rather than replaced. The only options for protecting such components from vibration, shock and/or thermal exposure is to flat pad, tape down, or mechanically secure such components.

The present invention provides molded pre-forms, methods to fabricate the molded pre-forms, and their use to protect electronic components and assemblies from damage due to vibration, shock and/or thermal exposure. Exemplary applications include down hole use in drill strings in wells, computer boards, printed circuit boards, computer modules and particularly portable computers and electronic components, automotive electronics, medical, aerospace electronics and military electronic to mention a few.

### DISCLOSURE OF THE INVENTION

According to various features, characteristics and embodiments of the present invention which will become apparent as the description thereof proceeds, the present invention provides a method of protecting electrical components in electrical devices which includes:

providing an electrical device that includes an electrical component;

providing a first molded form complementarily configured to cover a first portion of the electrical component;

providing a second molded form complementarily configured to cover a second portion of the electrical component; and

securing the electrical component between the first and second molded forms to protect the electrical component from damage caused by at least one of vibration, shock and thermal effects.

The present invention further provides a method of fabricating a molded form used to protect an electrical component which method involves the steps of:

a) providing an electrical device that includes an electrical component;

b) obtaining dimensional data of the electrical component;

c) modifying the obtained dimensional data of the electrical component;

d) fabricating a mold for molding a molded form that is substantially complementarily shaped to a first portion of the electrical component, the mold being complementarily shaped to the first portion of the electrical component by an operation that utilizes the modified dimensional data of the electrical component; and

e) molding a molded form using the mold.

### BRIEF DESCRIPTION OF THE DRAWINGS

The present invention will be described with reference to the attached drawings which are given as non-limiting examples only, in which:

FIG. 1 is a flowchart which shows the steps involved in fabricating molded and co-molded pre-forms according to one embodiment of the present invention.

FIG. 2 depicts an image of a PCB that was obtained by simply placing a PCB on a flat bed scanner and scanning the PCB to produce a file image.

FIG. 3 is a CAD image of the scanned PCB of FIG. 2.

FIGS. 4a-4c show a set of three molds that were made according to the present invention.

FIG. 5 shows a singular molded pre-form, with seated PCB, produced according one embodiment of the present invention.

FIG. 6 shows a “clam-shell” or hinged co-molded perform in an open position having a PCB therein.

FIG. 7 shows a “clam-shell” or hinged co-molded perform in a closed position.

FIG. 8 is a cross-sectional view of a section of a co-molded pre-form according to the present invention.

### BEST MODE FOR CARRYING OUT THE INVENTION

The present invention is directed to molded pre-forms, methods for fabricating the molded pre-forms, and the use of the molded pre-forms to protect electronic components and assemblies from damage due to vibration, shock and/or thermal exposure. Exemplary applications include down hole use in drill strings in wells, computer boards and particularly portable computers and electronic components, automotive electronics, aerospace electronics, medical, and military electronic to mention a few.

The molded pre-forms of the present invention are made from virtually any injectable material such as elastomers that can be molded and are sufficiently heat resistant and suitable for absorbing anticipated vibration and/or shock. The injectable material such as elastomers that are thermally conductive can be used to transfer heat from electronic components to chassis or other support structures, heat sinks, cooling structures, etc. Exemplary injectable materials include silicone based compositions with platinum based silicones being one particular example. The thermally conductive elastomer identified as 3-6655 and available from Dow Corning was determined to be particularly useful for purposes of the present invention. Another composition from Dow Corning identified as 3-6751 is a thermally conductive adhesive which was used to produce the hard thin outer layer. (It was not mixed with 3-6655). Other exemplary injectable materials include urethane compositions. The molded pre-forms of the present invention provided an effective alternative to potting/encapsulation techniques. In an effort to reduce costs and improve performance, the materials from which the molded pre-forms are should be soft enough to conform around the geometry of the electronic components but durable enough to be slid into chassis, housings, etc.

The present invention provides several types of molded pre-forms including those that are not reinforced, those that are reinforced by adding therein materials such as fiberglass scrim weave, carbon fibers, fiberglass structures those that are reinforced by embedding inserts therein, and those that are co-molded so as to have two or more layers having different properties. Examples of embedded inserts include metal mesh and metal foils which can provide for EMI shielding, and heat sinks including cables, wires, pins and other metal structures.

The pre-forms of the present invention were initially designed for use in conjunction with printed circuit boards (PCB) and other electronics packaging systems which, when in use, are subject to vibration and/or over heating. Although the pre-forms of the present invention are described herein for exemplarily purposes with reference to “down hole” applications, it is to be understood that the pre-forms of the present invention can be used in conjunction with virtually any PCB or electronic component or electronics package or assembly, etc., including computer boards and electronic components in both portable and non-portable computers, automotive electronic systems, aerospace electronic systems and military electronic systems to mention only a few.

As noted above, various embodiments of the present invention include singular molded pre-forms (also referred herein as simply “molded pre-forms), and co-molded performs.

Singular molded pre-forms are molded from one elastomer or injectable molding composition such as in the case of “down hole” application a thermally conductive material with shock damping characteristics or vice versa. Singular molded pre-forms lay like a blanket over a PCB to act as a: (1) path (conduit) to transfer heat from the PCB to a chassis, Sub or other structure; and (2) “sponge” to absorb vibration.

Co-molded pre-forms were developed according to the present invention to better facilitate the use of elastomer of other injectable molding materials that after molding may be soft and “sticky” and therefore difficult to slide into an enclosure or assembly. Otherwise, the molded materials may be easily damage during handling because of their softness.

Co-molded pre-forms are molded from/with two or more materials. Co-molded pre-forms can use the same singular molded material to blanket a PCB (to provide vibration damping and/or thermal conduit); however, they also have a hard outer thin shell that facilitates sliding or handling of a resulting enveloped PCB into an enclosure or assembly.

The molded and co-molded pre-forms of the present invention provide a convenient alternative to potting and encapsulation techniques. One particular aspect of the present invention is that the molded and co-molded pre-forms are easily removed and re-applied, allowing repair or replacement of individual electronic components or entire PCBs. Potted and encapsulated PCBs and electronic components are typically replaced rather than repaired, because the individual components are not accessible through the potting or encapsulation materials.

As will be understood from the description of the invention which follows, the molded and co-molded pre-forms of the present invention can be selectively configured to be optimized for heat management or for vibration or shock damping.

According to one embodiment, the molded and co-molded pre-forms of the present invention are fabricated by a unique process which involves producing an image of a PCB and using the image to fabricate a set of molds which are configured to match the shape of the PCB and dimensionally configured to optimize heat management and/or vibration or shock damping.

The fabricated tools/molds are used to injection mold the molded pre-forms and the co-molded pre-forms. According to one embodiment of the present invention which is discussed in detail below, a single set of three molds can be used to form either a molded pre-form or a co-molded pre-form for a given PCB. It is to be understood that the present invention is not limited to injection molding. The molded pre-forms and co-molded pre-forms can made by any combination of molding techniques, including but not limited to injection molding, spray molding, pour molding, etc.

FIG. 1 is a flowchart which shows the steps involved in fabricating molded and co-molded pre-forms according to one embodiment of the present invention.

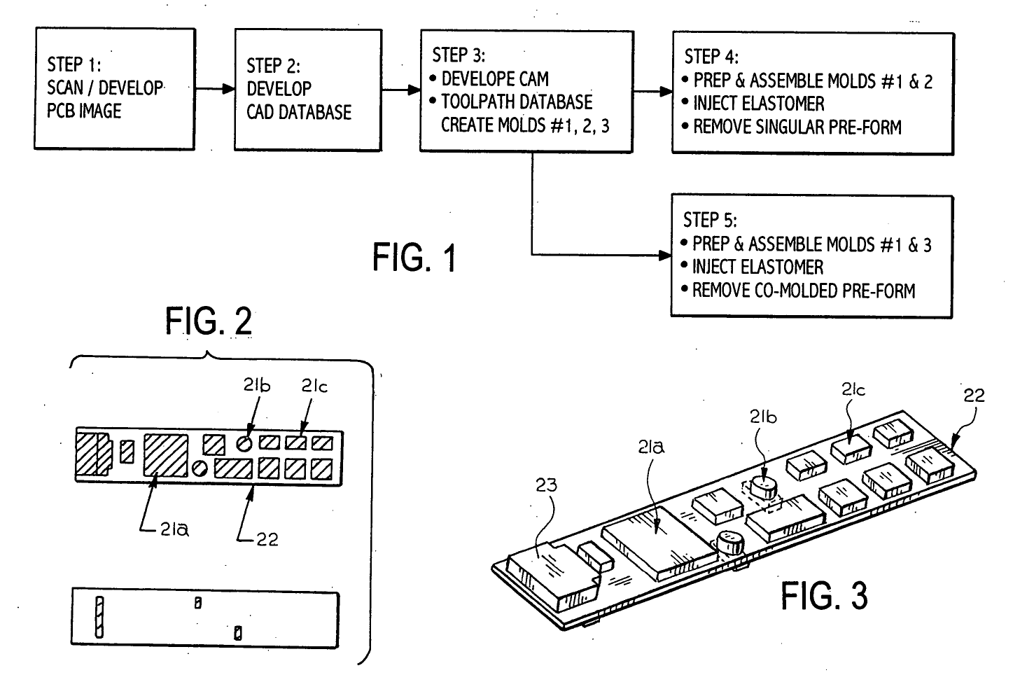

In step 1 an image of a PCB is produced. According to one embodiment of the present invention a PCB is scanned using any known scanning means or method capable of producing an image of the PCB. FIG. 2 depicts an image of a PCB that was obtained by simply placing a PCB on a flat bed scanner and scanning the PCB to produce a TIF file image. Other image formats such as jpg, bmp, and etc can also be used. The image 20 of the PCB in FIG. 2 depicts various electronic components 21a, 21b, 21c . . . 21 . . . which are mounted on printed circuit board 22. As depicted, the electronic components 21a, 21b, 21c . . . 21 . . . have different shapes and sizes which, according to the present invention are evaluated and used to produce molded pre-forms and co-molded pre-forms which conform to the overall configuration of the PCB.

In step 2 the image of the PCB is manipulated by a computer program to produce a CAD file. During the course of the present invention a software program called SolidWorks® was used to produce the CAD file and manipulate the CAD file image. For example, individual components are blocked out leaving approximately 0.03 to 0.05 inches around each component which provides clearance for the final mold or co-mold pre-form. This clearance space, which can be larger, will compensate for variances in the position of electrical components on similar configured PCBs which may vary. In high temp applications it is best not to put a preload on the tops of components due to the potential pressure applied from the expanding preform material which could result in damage. In such high temperature applications the clearance can be such that the preforms are just shy of touching the tops of the components. However, in lower temp application larger clearances can be used. The height of each component is measured. If thermal heat transfer/dissipation is the principle concern, the heights of the components in the CAD image are manipulated by subtracting from about 0.005 to about 0.02 inches from the measured heights of the components. This manipulation or adjustment will ensure that the mold will produce a molded or co-molded pre-form that puts a pre-load on top of each component and/or establishes a direct path for heat to travel.

If vibration and shock damping are principle concerns, the heights of the components in the CAD image are manipulated by adding about 0.03 inches to the measured heights of the components. Of course, as can be understood, the heights of the components do not have to be manipulated by any addition or subtraction in some applications where vibration, shock and thermal effects are moderate.

FIG. 3 is a CAD image of the scanned PCB of FIG. 2. As can be seen in FIG. 3, the CAD image has substantially identical structures for each of the individual components found in the scanned image of FIG. 2 with a structure 23 included to provide access to connect leads to the PCB.

In step 3 of FIG. 1, the modified CAD image is used to fabricate molds for molding the molded pre-forms and co-molded pre-forms. There are a number of computer programs available that can control the operation of machining equipment such as mills, rapid prototyping machines, silicon tooling machines, etc. that can be used to fabricate molds for the pre-forms. In an exemplary embodiment of the present invention, a computer software program called MasterCam® used the CAD image file to control a CNC mill which was used to fabricate a set of three molds which can be used to mold molded pre-forms and co-molded pre-forms.

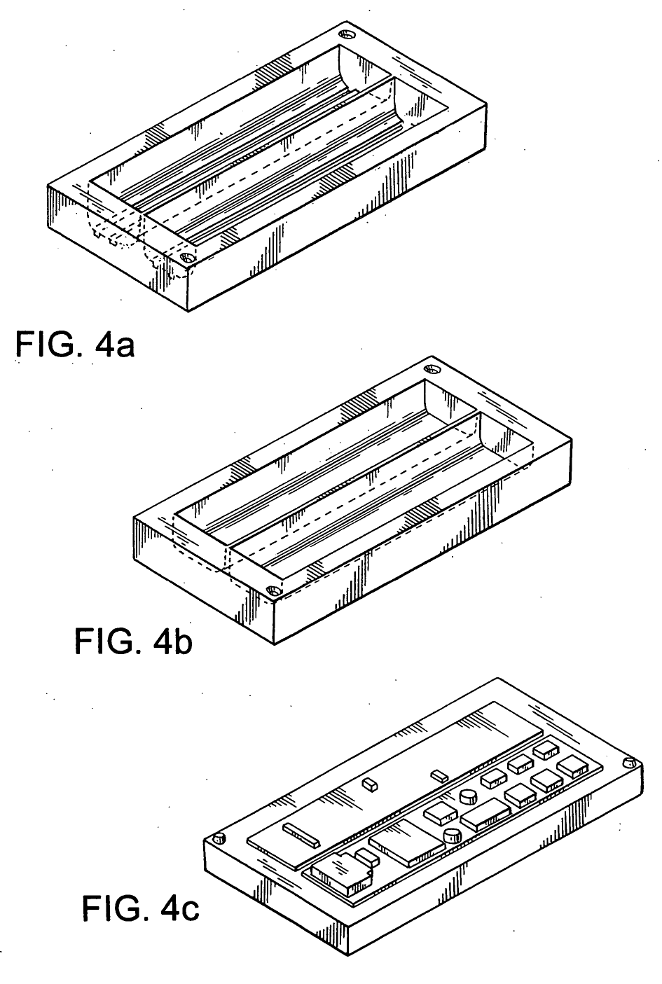

FIGS. 4a-4b show a set of three molds that were made by a CNC mill using MasterCam® according to the present invention. The first and second molds shown in FIG. 4c and 4b are used to mold a singular molded pre-form. The first and third molds shown in FIGS. 4c and 4a are used to mold the thin hard shell on the co-molded performs as explained in detail below.

In step 4 of FIG. 1, a singular molded pre-form is molded. Using the molds shown in FIGS. 4a-4c, the first and second molds shown in FIGS. 4c and 4b are used to mold a singular molded pre-form. In order to provide some structural rigidity to the molded pre-form, an insert such as a fiberglass scrim can be placed in the mold assembly before an elastomer composition is injected into the mold assembly. Other insert materials can be used including metal mesh or foil inserts which can provide for EMI shielding. Also, heat sinks, including cables, wires, pins and other metal structures can be embedded into the molded pre-forms. Stiffener materials such as flat, round or tubular configurations can also be added to the elastomer composition to improve the rigidity of the molded pre-forms.

After the elastomer composition is injected into the mold assembly, the mold assembly can be heated as desired to cure the elastomer composition.

The resulting molded pre-form can be removed from the mold assembly and used “as is.” Alternatively, the molded pre-form can be subjected to an additional molding process to form the co-molded pre-forms of the present invention.

In step 5 of FIG. 1, a co-molded pre-form is molded. Using the molds shown in FIGS. 4a-4c, the first and third molds shown in FIGS. 4c and 4a are used to mold a shell of a second harder material on the singular molded pre-form. If a co-molded pre-form is desired, the molded pre-form produced in step 4 should not be removed from the first mold shown in FIG. 4c. With the molded pre-form attached to the first mold shown in FIG. 4c, the first and second molds shown in FIGS. 4c and 4b are assembled together with the molded pre-form therein and a small clearance space between the outer surface of the molded pre-form and the inner surface of the third mold. A second composition that forms a hard shell is injected into the mold assembly. In an exemplary embodiment, the molded pre-form was produced using Dow Corning's 3-6655 elastomer composition and the hard shell was produced using Dow Corning's 3-6751 adhesive composition.

After the shell forming composition is injected into the mold assembly, the mold assembly can be heated as desired to cure the composition and produce a co-molded pre-from. It is of course possible to produce co-molded performs using more than two compositions.

After curing, the molded pre-form and/or co-molded pre-form are subject to finishing treatments, including removal of flash trim.

The molded and co-molded pre-forms of the present invention can be in the form of separate pre-forms pieces between which a PCB is sandwiched or a hinged or connected “clam-shell” structure in which a PCB is received.

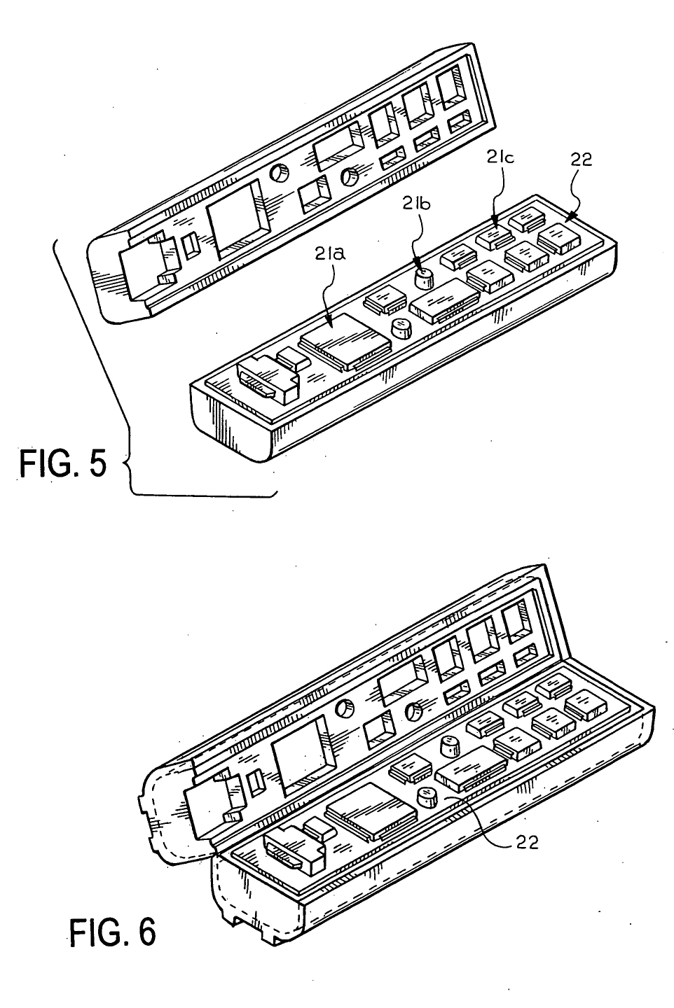

FIG. 5 shows a molded pre-form produced according one embodiment of the present invention. In FIG. 5 the molded pre-form above the PCB is lifted from the PCB to show the PCB. A similar molded pre-form is provided beneath the PCB in FIG. 5. The overlapping peripheral edges of the molded pre-forms which extend outward beyond the peripheral edge of the PCB can be sealed together with a suitable adhesive or glue. Alternatively, the PCB can be secured between the two portions of the molded pre-forms using mechanical means including tape, clips and adjacent support structures.

FIG. 6 shows a “clam-shell” or hinged co-molded perform in an open position having a PCB therein. As can be seen, the inner surface of the upper portion of the co-molded perform shown in FIG. 6 includes recessed portions which are complementary shaped to the electronic components which are to be received in the recessed portions. As in the case of the molded pre-form shown in FIG. 5, the overlapping peripheral edges of the upper and lower portions of the co-molded pre-form which extend outward beyond the peripheral edge of the PCB can be sealed together with a suitable adhesive or glue. Alternatively, the PCB can be secured between the two portions of the co-molded pre-forms using mechanical means including tape, clips and adjacent support structures.

The hinge structure between the upper and lower portions of the co-molded (or molded) pre-forms can be reinforced by a scrim or other structure embedded in the pre-molds.

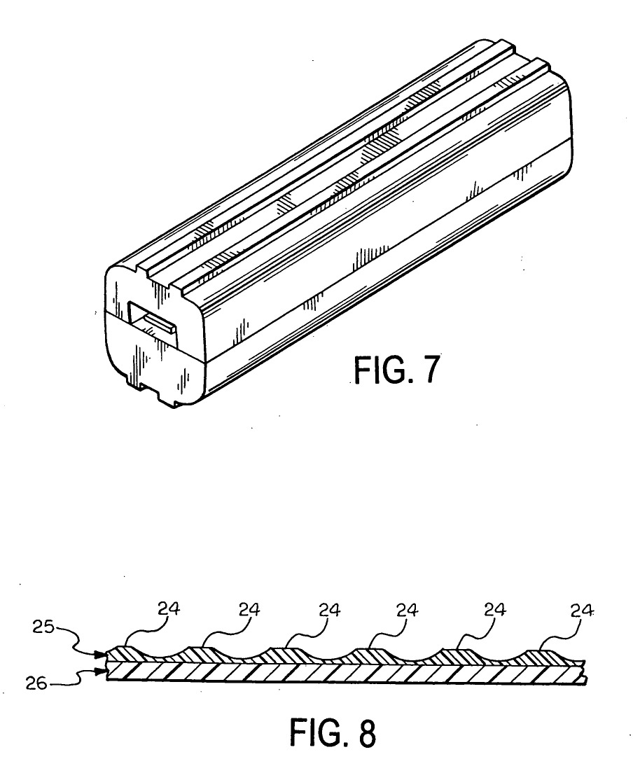

FIG. 7 shows a “clam-shell” or hinged co-molded perform in a closed position. The outer surface of the co-molded pre-form can be provided with ridges. The ridges which will be formed predominately if not exclusively of the composition used to for the hard shell will limit surface area and friction so as to enable the co-molded perform to be slid into an enclosure or assembly. The space between the ridges are used to accommodate thermal expansion also.

FIG. 8 is a cross-sectional view of a section of a co-molded pre-form which shows ridges 24 that are formed predominately if not exclusively of the composition used to for the hard shell 25. The underlying molded composition is identified by reference number 26 in FIG. 8.

Once sealed, the molded and co-molded pre-forms of the present invention are highly re-enterable. To open the sealed pre-forms, a knife is inserted along the parting line (between the upper and lower halves) and pre-forms are cut open. Once the assembly is opened the PCB board can be replaced or repaired and the pre-forms can be resealed by using a small amount of adhesive applied along the edges of the pre-molds or by taping the opened edge of the pre-molds closed. The ability to quickly replace and/or repair a PCB results in a huge cost saving by not having to “trash” the PCB. Moreover the ability to easily replace the PCB allows for easy upgrading.

The molded and co-molded pre-forms of the present invention help eliminate or significantly reduce board failure due to thermal expansion of the injectable molded material that is intended to protect the boards. This is accomplished by building a thermal expansion factor (typically 0.03″ to 0.05″) around each component of the PCB. In addition, since the pre-forms are not mechanically attached to the PCB, unlike encapsulation, the pre-forms can be removed without occurring damage. In lower temperature applications and when the boards are manufactured to high tolerance placement specs it may not be necessary to build in the 0.03″ to 0.05″ tolerance around each component.

The molding compositions can include conventional additives such as pigments, fillers, etc. Moreover while the molding process is not discussed in undue detail, conventional molding techniques including preparing and cleaning of mold surfaces and the use of release agents can be used in the molding process of the present invention.

As indicated above, the molded and co-molded pre-forms of the present invention are suitable for hostile environments in which electronic components, including PCBs are subject to extreme amounts of vibration, shock and/or thermal exposure. As such, the molded and co-molded pre-forms are useful in applications that involve “down hole” oil and gas well drilling logging and measurement activities. In addition to being useful in extremely hostile environments, the molded and co-molded pre-forms of the present invention are more than adequate for protecting electronic components, including PCBs in less hostile environments. For example, there are many electronic devices that are designed and constructed for portable, hand-held or field use, including portable computers, hand-held date acquisition devices, communication devices, data and communication up-link devices, global positional devices, remote control devices, etc. In addition, electronic components, including computer modules, other types of PCBs and other devices are increasingly being used in applications related to transportation such as engine, suspension, braking, climate and other control systems, navigational and onboard diagnostic systems, etc. In the aerospace industry electronic components, including computer modules, other types of PCBs and other devices are used in avionics electronics, satellite guidance, control and positional systems, aircraft engine controls systems, weapons systems, data recording (“blackbox”) devices, defensive systems, fire suppression systems, etc. The military in increasing using electronic components, including computer modules, other types of PCBs and other devices in weapons guidance and defense systems, observation and tracking systems, communication systems, etc. Overall electronics that include computers, computer modules, microprocessors, etc. are being adapted for many field and onboard applications which can expose the electron components to adverse heat effects or over heating, shock, vibration, acceleration and other forces that can damage the electronic components if precautionary steps are not implemented. Such applications in transportation devices such as motor vehicles, rail vehicles, aircraft, spacecraft, boats, vessels, etc. are suitable for the type of protection from shock, vibration and/or thermal effects that the molded and co-molded performs of the present invention provides.

The molded and co-molded pre-forms of the present invention are particularly suitable for protecting electronic components, including PCBs, computer modules, power supplies, including batteries, sub-assemblies, etc. in the applications exemplified above. Even in applications that involve minor vibrations such as household appliances, office equipment, and other stationary or transportable apparatus, the molded and co-molded pre-forms of the present invention can be used to protect associated electronic components from shock, vibration and/or heat effects.

According to one embodiment of the present invention as discussed above, an image scanner can be used to obtain the image of a PCB and used the data image to determine the geometry of the PCB for purposes of configuring a mold design for molding the pre-forms. Various types of electronic scanners or digital image acquisition devices can be used including flat bed scanners, movable scanning or imaging devices such as three-dimensional image cameras, and the like. In addition to electronic scanners and digital imagers, the geometry of a PCB or other electronic component can be obtained by physically manually measuring the geometry using measuring tools such as calipers, rulers, height gauges, or using automated devices including coordinate measuring machines (CMM's). Once the geometry of a PCB or other electronic component is obtained by any suitable method, the dimensional data of the geometry can be modify to the desired tolerances and used to configure a mold design for molding the pre-forms. It is of course possible to use or extract the geometry of a PCB or other electronics component that has been blueprinted or deigned in such a manner that involves the production of an engineering or design print or model.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above.

What is claimed is:

1. A method of protecting electrical components in electrical devices which comprises:
providing an electrical device that includes an electrical component;
providing a first molded form complementarily configured to cover a first portion of the electrical component;
providing a second molded form complementarily configured to cover a second portion of the electrical component; and
securing the electrical component between the first and second molded forms to protect the electrical component from damage caused by at least one of vibration, shock and thermal effects.

2. A method of protecting electrical components according to claim 1, wherein the electrical device comprises a portable electrical device.

3. A method of protecting electrical components according to claim 2, wherein the electrical device comprises a hand-held device.

4. A method of protecting electrical components according to claim 2, wherein the electrical device comprises a computer.

5. A method of protecting electrical components according to claim 1, wherein the electrical device comprises a computer module.

6. A method of protecting electrical components according to claim 5, wherein the electrical device comprises a computer module that is incorporated into a transportation device.

7. A method of protecting electrical components according to claim 6, wherein the transportation device is one of a motor vehicle, rail vehicle, aircraft, spacecraft, boat and vessel.

8. A method of protecting electrical components according to claim 1, wherein the electrical device comprises an appliance.

9. A method of protecting electrical components according to claim 1, wherein the electrical components comprises a circuit board.

10. A method of protecting electrical components according to claim 1, wherein the electrical component comprises a battery.

11. A method of protecting electrical components according to claim 1, wherein the first and second molded forms comprises co-molded forms.

12. A method of protecting electrical components according to claim 1, wherein the co-molded forms comprise an outer surface layer that is harder than a central portion of the co-molded forms.

13. A method of protecting electrical components according to claim 1, wherein the first and second molded forms are molded together about a hinge.

14. A method of fabricating a molded form used to protect an electrical component which method comprises the steps of:
a) providing an electrical device that includes an electrical component;
b) obtaining dimensional data of the electrical component;
c) modifying the obtained dimensional data of the electrical component;
d) fabricating a mold for molding a molded form that is substantially complementarily shaped to a first portion of the electrical component, said mold being complementarily shaped to the first portion of the electrical component by an operation that utilizes the modified dimensional data of the electrical component; and
e) molding a molded form using the mold.

15. A method of fabricating a molded form used to protect an electrical component according to claim 14, wherein the step b) of obtaining dimensional data of the electrical component comprises at least one of obtaining an image of the electronic component and physically measuring the dimensions of the electronic component.

16. A method of fabricating a molded form used to protect an electrical component according to claim 14, wherein the step c) of modifying the obtained dimensional data comprises at least one of adding or subtracting a factor to at least portions of the obtained dimensional data.

17. A method of fabricating a molded form used to protect an electrical component according to claim 14, wherein the electrical device comprises a portable electrical device.

18. A method of fabricating a molded form used to protect an electrical component according to claim 17, wherein the electrical device comprises a computer.

19. A method of fabricating a molded form used to protect an electrical component according to claim 14, wherein the electrical device comprises a computer module

20. A method of fabricating a molded form used to protect an electrical component according to claim 19, wherein the computer module is incorporated into a transportation device.
